(19) United States
(12) Patent Application Publication
(10) Pub. No.: US 2004/0151540 A1
(43) Pub. Date: Aug. 5, 2004

(54) Door, window, crown and baseboard molding system with hidden fasteners and pre-formed corner receptacles and couplers

(76) Inventors: Rodney J. Clements, Manteca, CA (US); Bradley S. Clements, Stockton, CA (US)

Correspondence Address: R. MICHAEL WEST LAW OFFICES OF, R. MICHAEL WEST, A PROFESSIONAL CORPORATION, 455 CAPITOL MALL; SUITE 405, SACRAMENTO, CA, 95814-4603, US

(21) Appl. No.: 10/738,355

(22) Filed: Dec. 16, 2003

Related U.S. Application Data
(60) Provisional application No. 60/439,583, filed on Jan. 10, 2003.

(51) Int. Cl. F16D 1/00

(52) U.S. Cl. 403/408.1

(57) ABSTRACT

A door, window, crown and baseboard molding system with hidden fasteners and pre-formed corner receptacles and couplers. The outer face of a molding piece includes at least one elongated kerf or groove along its length. The width of the groove is sufficient to accommodate the head of a nail or screw fastener. With the molding piece properly aligned against a wall, fasteners are successively located in spaced relation within the groove and driven into the wall. With the heads of the fasteners recessed within the groove, the groove is filled with a piece of material or injected caulking. Pre-formed corner receptacles may be employed where the molding encounters inside and outside corners. The couplers are used to join two lineal pieces of molding or as decorative accents along the molding. Receptacles and couplers include end recesses sized and configured to accommodate and cover the end of a piece of molding.

### CROSS-REFERENCE TO A RELATED APPLICATION

Pursuant to the provisions of 35 U.S.C. Section 119(e), Applicants claim the priority benefits of their Provisional Patent Application Serial No. 60/439,583, filed Jan. 10, 2003, entitled Pre-Finished Fastenerless And Concealed Fastener Door Frame And Molding System.

### BACKGROUND OF THE INVENTION

1. Field of the Invention

The invention relates generally to decorative molding and trim used in building construction and remodeling, both residential and commercial. More particularly, the invention pertains to molding and trim featuring pre-finished molding pieces provided with a hidden fastener system, and pre-formed corner receptacles and couplers for use with molding and trim pieces.

2. Description of the Prior Art

The conventional and still most widely used method of installing decorative trim and molding pieces is to cut, install, and paint or stain finish the pieces in the field. The trim and molding pieces are typically made either from unfinished or primed paint grade material or from unfinished stain grade material. This unfinished material is sent to the building site uncut, for use as window or door trim, as baseboard, as crown molding, or as decorative trim on intermediate portions of walls.

When it comes time to install the trim or molding pieces, the installer measures and cuts the pieces, precisely to fit the dimensions of the particular job site application. Where the molding or trim must pass around a corner, accurate complementary miter cuts must be made, to avoid unsightly gaps in the molding. Similarly, where long, lineal runs of multiple pieces of baseboard or crown molding are made, right angle cuts must be accurate for the same reason. After the various pieces are properly cut to size, nails or screws are installed through the outer face of the pieces, to attach the trim to the door or window frame, or to the supporting wall.

After the installer completes the installation of the trim and molding pieces, a painter is called upon to caulk or fill the abutting joints, fill the nail or screw holes, and then sand the entire exposed surfaces of the pieces to present a smooth finish. Primer and finish coats of paint or stain are subsequently applied to complete the job.

Another less common method for nailing molding pieces into place is blind nailing. To blind nail, a small knife or gouging tool is used to raise a sliver of wood from the molding. The resultant cavity is large enough to hide the head of a finishing nail. The sliver is not entirely detached from the molding. By leaving a small portion of the sliver still attached to the molding, replacement into its natural position is possible. After pulling the sliver to the side, a finishing nail is driven into the cavity securing the molding to the backing board or frame. Then, the sliver is glued back into place, using a piece of masking tape to hold it fast until the glue is set. Finally, the spot is sanded to remove all trace of the sliver re-installation.

The above-described processes for installing and finishing trim and molding are both expensive and time consuming. In addition, these procedures are difficult for the average do-it-yourself home owner to accomplish successfully. The principal difficulties stem from the requirements for accurate field cutting and competent field finishing, of the trim and molding pieces.

### SUMMARY OF THE INVENTION

The molding system of the present invention contemplates the use of completely or partially pre-finished molding pieces provided with hidden fasteners. The molding system may be used for any type of molding or trim application, for example, windows, doors, baseboards, ceiling crowns, wall decorations, chair rails, window stools, aprons, shelves, hook strips, or cleats. The pre-finished molding pieces may be milled, cut, formed or extruded from a variety of different materials, including wood, plastic, vinyl, and composites.

The fasteners for the molding are hidden by providing at least one elongated kerf or groove, in the outer face of each molding piece. The width of the groove is sufficient to accommodate the head of a nail or a screw fastener. The fasteners are installed in spaced relation within the groove, to extend through the molding and affix it securely to the wall or backing structure. The depth of the groove is such that the heads of the installed fasteners are recessed below the outer face of the molding. The groove is then filled with a strip of thin material or injected caulking, covering the heads of the fasteners therein.

Another feature of the molding system is the pre-formed corner receptacles and couplers for use with pieces of molding or trim. Pre-formed corner receptacles are employed where the molding encounters inside and outside corners. The couplers are used to join two lineal pieces of molding or as decorative accents along a length of the molding.

Receptacles and couplers include end receivers sized and configured to accommodate and cover the end or intermediate portions of a piece of molding. The receivers further include retaining means in the form of an upper lip and a lower trough, configured to surround the upper and lower portions of the molding. The upper lip and the lower trough, acting in concert with the back face of the receptacle or coupler, secure the receptacle or coupler to the molding. In this manner, the retaining means holds the receptacles and couplers in place without the use of fasteners or adhesives. The receptacles and couplers are therefore termed “fastener-less”. Optional lineal ribs may be provided within the recesses, to engage the kerf or groove within the molding and additionally secure the molding therein.

The hidden fastening system and the “fastener-less” pre-formed corner receptacles and couplers disclosed herein, eliminate the above-recited requirements of the prior art installation and finishing method. The hidden fastening system in combination with pre-finished trim and molding pieces, eliminates the additional time, skill, and expense of filling nail or screw holes, and sanding masking, and painting the molding pieces after installation. The “fastener-less” pre-formed corner receptacles and couplers eliminate the additional time, skill, and expense associated with making precise miter and other angle cuts, as well as eliminating filling, sanding, and finishing the joints which are created between exposed abutting pieces. In addition, the pre-formed corner receptacles and couplers may be used advantageously to create and enhance the decorative value of the trim and molding pieces in ways which are difficult and expensive to accomplish with the prior art installation and finishing methods.

These and other objects will be described below in the drawings and the detailed description of the preferred embodiment to follow.

### BRIEF DESCRIPTION OF THE DRAWINGS

FIG. 1 is a fragmentary perspective view of the interior of a house, showing the molding with hidden fasteners, the corner receptacles, and the couplers of the present invention, variously installed around a door and a window, and used as crown molding and as baseboard;

FIG. 2 is a fragmentary perspective view of a piece of molding installed with nails, with a piece of resilient strip material shown partially installed in the upper kerf;

FIG. 3 is a fragmentary, cross-sectional view, showing a piece of molding with upper and lowers kerfs and nails and resilient strip pieces installed therein;

FIG. 4 is an exploded, fragmentary, perspective view of the ends of two pieces of molding and a “fastener-less” pre-formed coupler therebetween;

FIG. 5 is a rear perspective view of a 90° “fastener-less” pre-formed corner receptacle, showing the two receivers, the retaining means including the upper lips and the lower troughs, and the upper and lower ribs;

FIG. 6 is an exploded, fragmentary, perspective view of the molding in combination with inner and outer corner receptacles;

FIG. 7 is a fragmentary top plan view of a 90° radius corner receptacle, coupled with the end portions of two pieces of molding;

FIG. 8 is a fragmentary top plan view of a 135° corner receptacle, coupled with the end portions of two pieces of molding;

FIG. 9 is a fragmentary top plan view of a 120° corner receptacle, coupled with the end portions of two pieces of molding;

FIG. 10 is a fragmentary, cross-sectional view of a piece of molding attached to a wall with the kerf filled with a resilient piece of rubber or plastic;

FIG. 11 is a fragmentary, cross-sectional view of a piece of molding attached to a wall with the kerf filled with injected caulking;

FIG. 12 is a fragmentary, cross-sectional view of a piece of molding attached to a wall with the kerf filled with a strip of material;

FIG. 13 is an exploded perspective view of a corner assembly of door or window molding, showing the corner receptacle, end portions of door or window molding, fasteners, and strip material;

FIG. 14 is a view as in FIG. 13, but with the corner assembly fully installed;

FIG. 15 is an exploded perspective view of a corner assembly of crown molding, showing the corner receptacle, end portions of crown molding, fasteners, and strip material;

FIG. 16 is a fragmentary perspective view showing both inner and outer corner assemblies of crown molding; and,

FIG. 17 is a fragmentary, cross sectional view, taken through the line 17-17 in FIG. 16.

### DETAILED DESCRIPTION OF THE PREFERRED EMBODIMENT

Turning now to the drawings, and in particular to FIG. 1, multiple applications for the pre-finished molding pieces and the “fastener-less” pre-formed corner receptacles and couplers of the present invention are shown. Starting first with the baseboard molding 11, a plurality of lineal pieces of molding or trim 12 are variously interconnected to cover the right-angle interface between the floor 13 and the wall 14. Molding pieces 12 are typically elongated in configuration, varying from 1′ to 3″ or so in transverse dimension, and from 8′ to 16′ in length. Decorative features, such as curves, grooves, ridges are usually included in the outer surface 16 of the molding 12 to add visual appeal and interest.

An important aspect of the present invention is the partial or complete pre-finishing of all molding pieces prior to installation. By this it is meant that paint-grade molding has preferably been sanded, primed, and painted at the place of manufacture. Similarly, for stain-grade molding, pre-finishing means that it has been sanded, stained, and perhaps covered with a protective clear coat at the factory. It is also possible that the present invention could be practiced with something less than complete pre-finishing before installation, yet the major benefits of the invention could still be enjoyed. For example, paint-grade molding could be sanded and primed before installation, leaving final painting after all molding has been installed. Also, stained molding could also be coated with a varnish or other clear coat after installation. In either case, no sanding or other time-consuming preparatory work would be necessary.

While wood is the traditional molding material, other materials are becoming more popular and could be used to advantage in the present instance. Plastic, vinyl, or composite molding would be well adapted for use herein, as paint or stain coloring could be added to the material before it has been injected or cast into the shape of the molding. Thus, such injected or cast molding would have the advantage of being completely pre-finished at the factory, with a minimum of labor and finishing steps.

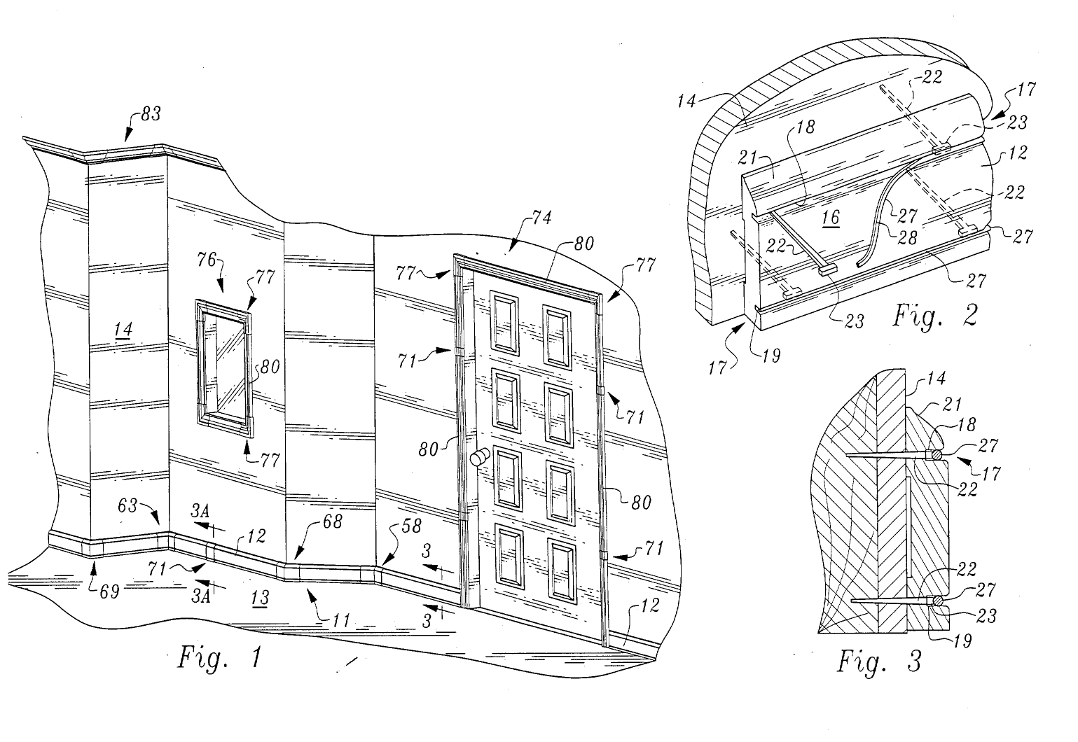

FIG. 2 shows a close-up detail of one embodiment of the hidden fastener system 17 for the molding 12. The fastener system 17 includes an upper kerf or groove 18 and a lower kerf or groove 19 in the outer surface 16 of molding piece 12. Preferably, kerfs 18 and 19 extend longitudinally along molding 12, from one end to the other end. The use of two such parallel kerfs balances the attachment forces applied to the molding, and has proven more than adequate for molding of typical size. While it is not necessary that the kerfs extend the entire length of the molding, it is apparent that at least one kerf must be provided in the outer surface 16, for at least one molding fastener to be installed. It should also be noted that the kerfs may also be arranged transversely with respect to the molding, extending, for example, from side to side at the top, bottom and median portions of the molding.

It is also preferable that the kerfs be strategically located within or adjacent a feature or detail in the molding, both to enhance and to merge the visual appearance of the two. Although molding 12 is a very plain example of decorative molding, it includes one such detail, a curved portion 21 extending along its upper edge. Upper kerf 18 is located adjacent curved portion 21, providing a lineal visual cue which draws further attention to portion 21. Other locations and arrangements for the kerfs and details will be discussed and shown herein.

A first type of fastener, namely, nails 22, are shown in FIGS. 2 and 3. Kerfs 18 and 19 are sized and configured both to accommodate and to hide, the heads 23 of nails 22. Heads 23 are rectangular in plan, to conform to the rectilinear configuration of the kerfs. Nails 22 may be installed using a special tool (not shown) which grasps the head 23 and maintains proper alignment between the head 23 and the sidewalls of the kerf, when the nail is being driven. The width, or transverse dimension of the kerfs is selected to pass the corresponding width of the head 23: In addition, the depth of the kerfs is selected so that when the nails 22 are installed and fully seated in the floor of the kerfs, the heads are hidden from view by being recessed below the outer surface 16 of the molding 12. Although conventional finishing nails may be used as fasteners, the installation of finishing nails in this application is more difficult and time consuming than for installation of the disclosed nails 22.

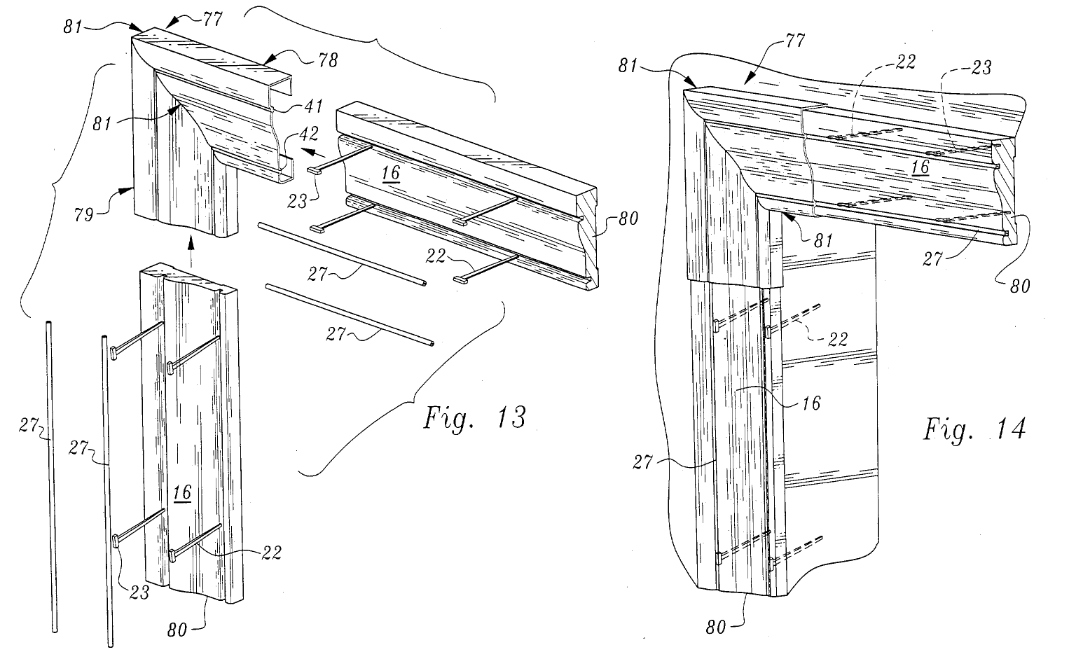

Yet another fastener, a screw 24, is shown in FIG. 11. Screw 24 includes a drive head 26, which is sized and configured to pass through the width of the kerfs and seat upon their floors. As with nails 22, when screws 24 are fully seated, the heads 26 are recessed below the outer surface 16 of the molding 12. Screw 24 may be installed using a power-driven screwdriver, and may provide additional strength for securing the molding in place, where necessary.

The hidden fastener system of the present invention also includes a variety of means for filling the kerf or groove in the outer surface of the molding, and for covering the head of the fastener so it is completely hidden from sight. A first filling means is a resilient cord 27, made from vinyl, plastic, or rubber material. Cord 27 may be solid or hollow, and may also include a plurality of small ribs 28 or protuberances in its outer surface. FIG. 2 shows a piece of cord 27 in the process of being installed within kerf 18, after a nail has been fully seated. Because cord 27 is resilient, is can be press-applied into kerf 18 without any special tools. However, a roller with an accommodating groove, such as a spline installation device used to install similar material in the frame of a door or window screen, may be used to advantage. The ribs 28 facilitate easy installation, and act effectively to grip the sidewalls of the kerfs. With the cord 27 fully installed, the heads 23 of the nails are completely covered and hidden. (See, FIGS. 2 and 3). It is also apparent that to perform this function, the overall depth of the kerfs must be substantially equal to the combined dimensions of the height of the fastener head and the thickness of the cord 27.

A second filling means is caulking 29, or another like material which can be injected in a fluid state, and then become hardened over time. As shown in FIG. 11, caulking 29 is injected into kerf 18, substantially filling the kerf and covering the head 26 of screw 24. The outer surface of caulking 29 may be manipulated while fluid to present a flush surface with outer surface 16. Alternatively, caulking 29 may be formed to present a concave surface, accentuating the transition between outer surface 16 and curved portion 21. The adhesive properties of caulking 29 act to secure the caulking within the kerf. Since caulking may be purchased in various matching or contrasting colors, the color of the caulking may be selected to provide the desired visual effect in combination with the color of the pre-finished molding piece 12.

A third filling means, shown in FIG. 12, is a strip 31 made from a more rigid material, such as wood, plastic, vinyl, or composite material. Strip 31 should have some flexibility for ease of installation, but its nature would essentially be hard and incompressible. For that reason, if the strip, as installed, is to be without undulations and fully seated so as to be flush with the outer surface 16, the depth of the kerf must be at least equal to the combined height of the fastener head and the thickness of the strip. If strip 31 were manufactured from a wood product, it could be pre-finished exactly in the same fashion as molding 12. Thus, after installation, strip 31 would precisely match the color and appearance of the associated molding. Similarly, if the molding were manufactured from plastic, vinyl, or composite, identical material can be used for strip 31, visually integrating the strip with the molding. And, as mentioned above, the pre-finished molding can also be painted after installation of the filling means, whether it be a cord 27, caulking 29, or a strip 31.

The baseboard molding system 11 disclosed herein may be installed using conventional methods, where separate pieces of molding 12 are joined in abutting relation. This occurs where the lineal pieces are joined in a corner, or where lineal pieces are joined in lineal relation to form a longer piece of molding. In other words, in attaching the molding 12 to the wall, the hidden fastener system 17 is employed. However, where discrete pieces of molding are joined, the prior art method of miter cutting for angled joints and butt cutting for straight line junctures may be used. As part of this process, a bead of caulking compound or a series of dabs of the caulking compound is applied onto one of the abutting surfaces, before assembly of the pieces. As the opposing pieces are pressed together tightly to form the joint, any excess caulking is forced outwardly and wiped off, filling any gaps or voids between the pieces which existed previously.

However, this prior art method of conjoining molding pieces takes a substantial amount of time and skill, as it requires accurate measurements, accurate cutting, and skillful assembly. Another aspect of the present invention simplifies and quickens the assembly of multiple pieces of molding through the use of pre-formed corner receptacles and pre-formed couplers. These receptacles and couplers may be used advantageously with the pre-finished molding and hidden fastener system described above, or the receptacles and couplers may be used with conventionally attached molding, as well.

Corner receptacles are employed where the molding encounters and must pass smoothly around, the inside and outside corners in a building's walls or around the corners of a door or window frame. The corner receptacles may be formed to join molding piece at various angles, ranging from acute angles to obtuse angles. The corner receptacles are designed to be used on both inside and outside corners, to install baseboard, crown molding, chair rails, picture molds, or wainscot. In addition, corner receptacles can be made specifically for either a square corner or a radius corner application.

The couplers, on the other hand, are primarily used to join two lineal pieces of molding and maintain them in lineal relation. However, the couplers may also be slid over and arranged in spaced relation along a piece of molding, to provide decorative accents. Both the corner receptacles and the couplers may be manufactured from wood, plastic, vinyl, or composite materials.

A 90°, outer corner, baseboard receptacle 32 is shown in FIGS. 5 and 6. Receptacle 32 includes a first receiver 33 and a second receiver 34, sized and configured to accommodate and cover the ends of respective pieces of molding 12 inserted therein. First receiver 33 includes a cavity 35 extending from an open outer end to an inner end. Cavity 35 has upper and lower boundaries defined by an upper lip 36 and a lower trough 37. Similarly, second receiver 34 includes a cavity 40 extending from an open outer end to an inner end. Cavity 40 has upper and lower boundaries defined by an upper lip 38 and a lower trough 39. Receivers 33 and 34 are mirror images of each other, with the inner ends of their respective cavities 35 and 40 meeting at a 90° outer corner juncture 45.

An upper rib 41 and a lower rib 42 are provided on the inner walls 43 and 44 of receptacle 32. Ribs 41 and 42 extend or protrude inwardly into recesses 33 and 34. Ribs 41 and 42 are sized and configured to conform to the size and configuration of upper kerf 18 and lower kerf 19, in the outer surface of molding 12. In addition, the axes of ribs 41 and 42 are at vertical heights which respectively align with upper kerf 18 and lower kerf 19, when a piece of molding 12 is inserted into either end of receptacle 32.

Also shown in FIG. 6 is a 90°, inner corner, baseboard receptacle 46. Baseboard receptacle 46 is identical in its features with outer corner receptacle 32, except that it has a first receiver 47 and a second receiver 48 which are joined at a 90° inner corner juncture 50. Owing to the identity of its other physical and operational features to those of the receptacle 32 described above, no further detail regarding inner corner receptacle 46 is believed necessary.

The piece of molding 12 which extends between receptacle 32 and receptacle 46 is cut to a length which corresponds to the distance between the outer and inner corners, less ½ of the total horizontal extent of the receivers 34 and 47. This will result in a piece of molding which is inserted into the receivers of the two receptacles, approximately 1/2 of their horizontal depth or extent. A typical length for the receivers 33, 34, 47, and 48 would be 2″, although these components may be extended up to 12″, or more, as desired, depending upon the application. In FIG. 6, an inner end 49 of a first piece of molding 12 and an inner end 51 of a second piece of molding 12 are shown in broken line, to represent the extent of insertion of the two pieces of molding into the receptacle 46. Assuming that the receivers are 2″ in length, the extent of insertion in either receiver would be approximately 1″.

It is apparent that through the use of such receptacles, the installer need not precisely cut the molding pieces to be joined together to pass around corners. Nor do the cuts themselves have to be perfectly executed, since the ends of the pieces of molding are completely covered by the receptacles. Installation of the molding is easier, faster, and produces visual results which are aesthetically pleasing. Use of caulking to fill miter corners is entirely eliminated, and instead, a solid, perfectly formed corner is presented by every receptacle.

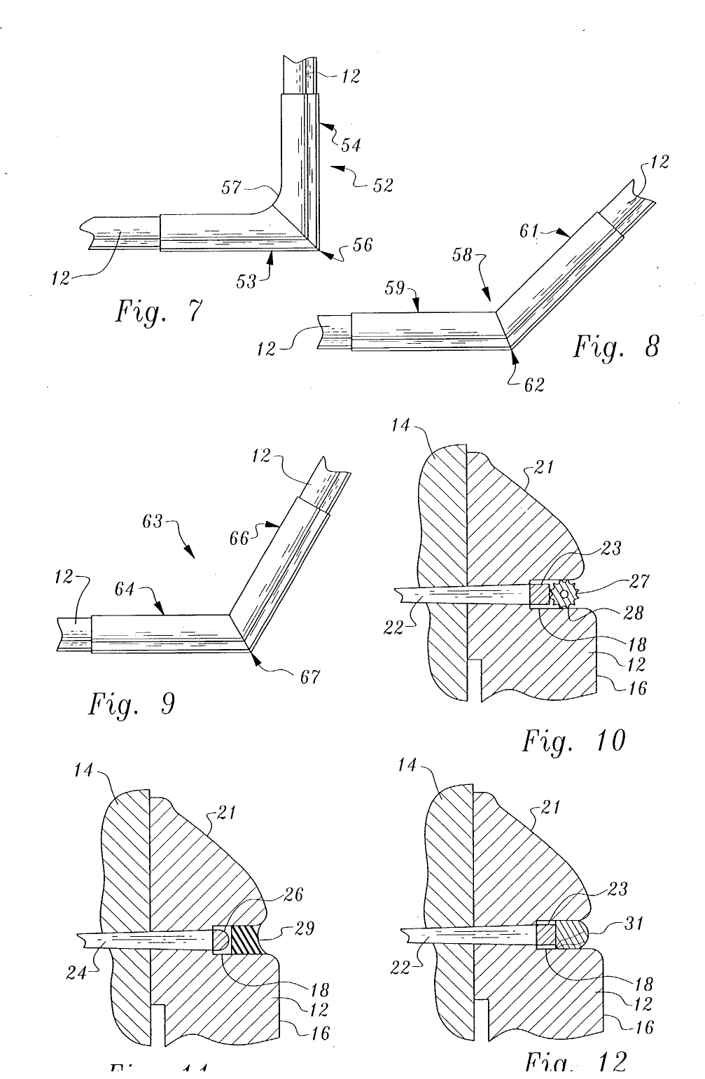

Another variant of the receptacle construction is a 90° inner corner radius receptacle 52, shown in FIG. 7. For decorative purposes, it may be desirable to employ a radius in the molding where it rounds a corner. Receptacle 52 includes the standard first receiver 53 and the second receiver 54, identical in construction and operation as the receptacle receivers discussed previously. However where the inner ends of the receivers 53 and 54 meet, an inner corner radius juncture 56 is provided. It will be noted that the exposed, inner portion of the juncture 56 includes a radius 57, rather than a sharp 90° corner. Although not shown in the drawings, a 90° outer corner radius receptacle may also be constructed, in which the juncture between the receivers would include an outer corner radius, rather than a sharp 90° corner.

Examples of receptacles designed to accommodate different angular orientations for abutting walls are shown in FIGS. 8 and 9. FIG. 8 illustrates a 135° inner corner receptacle 58, coupled with the end portions of two pieces of molding 12. As with the other receptacles of the present invention, receptacle 58 includes a first receiver 59 and a second receiver 61, sized and configured to receive the ends of the molding 12. A 120° inner corner receptacle 63 is shown in FIG. 9. Receptacle 63 includes a first receiver 64 and a second receiver 66 joined by an inner corner juncture 67. Receivers 64 and 66 are adapted to receive the end portions of two pieces of molding 12, in a manner identical to that performed by the receiver receptacles described above.

These 135° and 120° inner corner receptacles also may be constructed as outer corner receptacles, for the same angular orientations. These constructions of receptacles assembled in combination are shown in FIG. 1. Note the 135° inner corner receptacle 58 followed by a 135° outer corner receptacle 68, and the 120° inner corner receptacle 63 followed by a 120° inner corner receptacle 69. Receptacles have other angular orientations ranging from acute to obtuse angles may also be constructed, using the same principles and features described above.

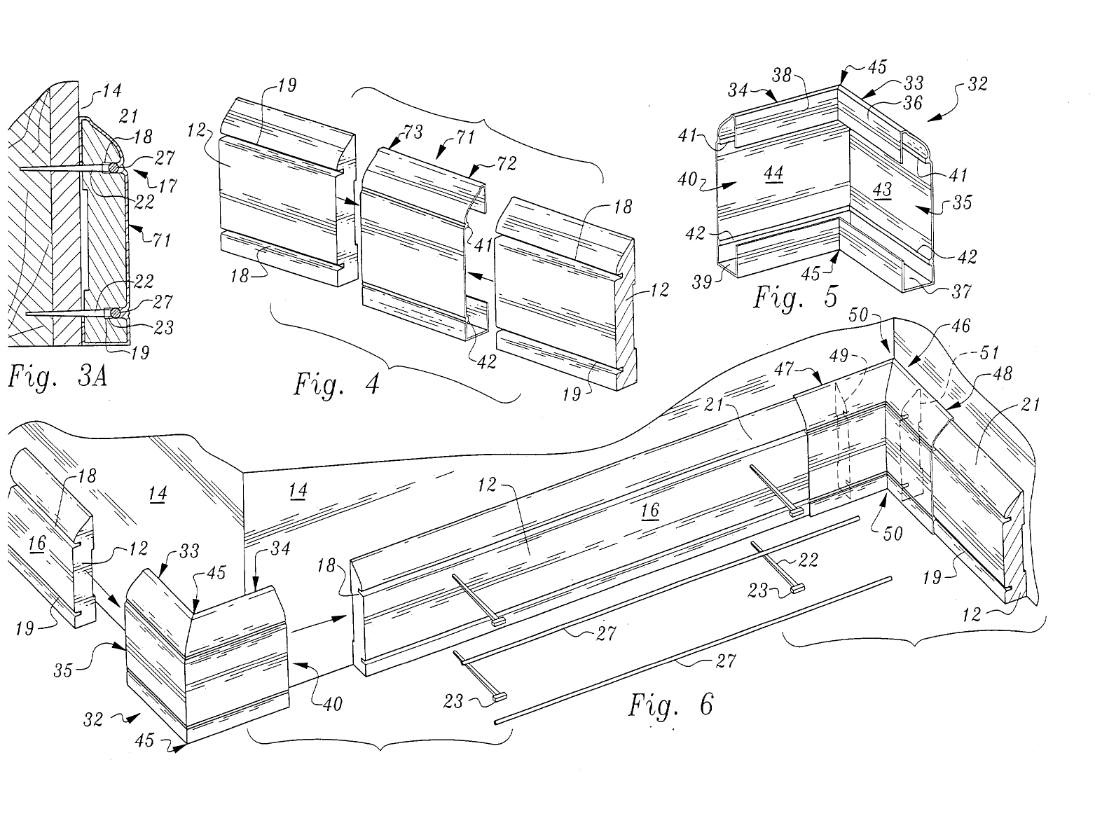

For the purpose of joining lineal runs of molding, pre-formed couplers are provided. In FIG. 4, a molding coupler 71 is shown in combination with ends of two pieces of molding 12 to be joined together. Coupler 71 includes, at opposing ends, a first receiver 72 and a second receiver 73. Optional for inclusion in coupler 71 are an upper rib 41 and a lower rib 42, identical to those used in connection with the previously described corner receptacles. Coupler 71 can be made of the same material as the corner receptacles used for a given installation, or it may be made of different material for accent or for decorative purposes.

The length of coupler 71 may vary with the application, but typical lengths would be in the 2″ to 12″ range. There is sufficient room in the combined lengths of first receiver 72 and second receiver 73 to accommodate the end portions of the two pieces of molding 12 yet maintain some adjustment flexibility. In other words, if the coupler were 6″, the end portions of the molding may extend 2″ or so into respective receivers, leaving 2″ between the molding ends for adjustment and ease of installation.

Another use of coupler 71 is for decorative purposes, mounted along the length of a piece of molding rather than joining two separate pieces of molding. In this application, the coupler 71 may also include additional details or features on its outer surface, to draw more attention to the coupler as an aesthetic feature along the molding. No change in the internal structural aspects of the coupler 71 would be required for this different application. The coupler 71 would simply be slid over a single piece of molding until the desired location is reached. Then, the piece of molding would be installed as previously described, preferably but not necessarily, using the hidden fastener system.

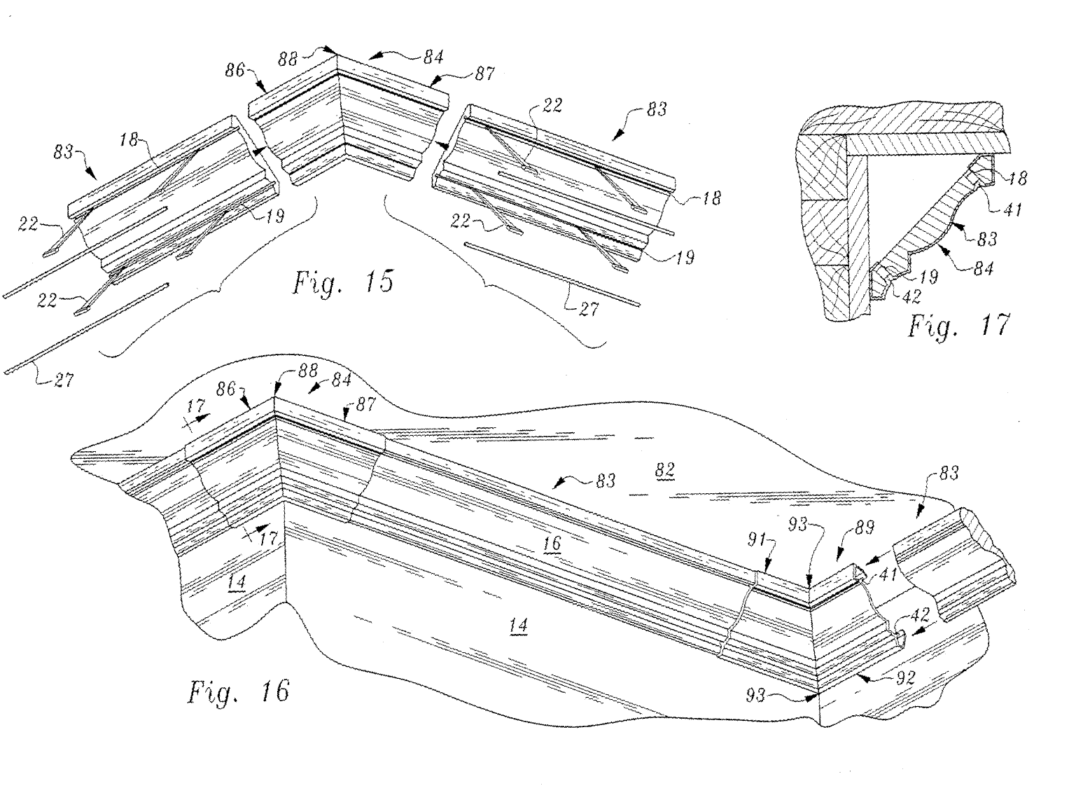

Other typical uses for the molding, receptacle, and coupler constructions of the present invention include the door 74 and the window 76 trim applications, as shown in FIG. 1. The detail illustrations for both of these applications are shown in FIGS. 13 and 14, where two pieces of pre-finished picture-frame molding 80 meet in a “fastener-less” picture-frame corner receptacle 77.

Molding 80 is different from the previously described molding 12, only in that more detail and relief are used on its outer surface 16. Such detail and relief are typical with picture-frame molding or trim. It should be noted, though, that molding 80 includes an upper kerf 18 and a lower kerf 19 in its outer surface, identical to those kerfs used in molding 12. It should also be noted that nails 22 and resilient cord 27 are used in this application as part of the hidden fastening system to affix the molding 80. All of the variations on the fastening system previously described may be used, or alternatively, the molding may be affixed conventionally, and only the receptacles 77 used.

A first receiver 78 and a second receiver 79 are provided to receive respective ends of a piece of molding 80. The receivers 78 and 79 may also include an upper rib 41 and a lower rib 41, to mate with upper kerf 18 and lower kerf 19 in the outer surface 16 of each piece of molding 80. However, the above-described retaining means, provided by the upper lip and the lower trough, are entirely adequate to secure the molding ends within the “fastener-less” picture-frame corner receptacle 77, without the use of the upper and lower ribs. In all other respects, as well, receivers 78 and 79 are constructed identically to the receivers of the receptacles described above, so in the interest of brevity, no further explanation regarding their structure will be provided.

Receivers 78 and 79 meet at picture-frame juncture 81, to form a 90° corner transition between the molding pieces. This allows the picture-frame corner receptacle 77 to be used to apply the inverted U-shaped trim around doors, or to form a complete picture frame trim arrangement around windows. For a typical assembly of molding 80 around a door 74, the left hand piece may initially be fitted with additional molding couplers 71 along its length, merely included in this application for decorative purposes. The second receiver 79 of a receptacle 77 is installed over the upper end of the left-hand piece of molding, before the molding is attached to the door frame. Then, an upper piece of molding 80 is installed in the first receiver of the receptacle 77 and in the first receiver of a second receptacle 77, at the upper right hand corner. The right hand piece of molding may be fitted with molding couplers 71 to match those on the left hand piece. Then the right hand piece of molding is installed in the second receiver of the second receptacle 77. Then, all of the remaining molding is attached to the door frame, and the installation is complete. If the hidden fastening system is used, the two kerfs will be filled. If conventional fastening is used, the holes must be filled and sanded before the final finish can be applied.

A final application for the molding, receptacle, and coupler constructions of the present invention is for crown molding. This application is shown in detail in FIGS. 15, 16 and 17. Crown molding is usually applied at the intersection between the wall 14 and the ceiling 82. The outer surface 16 of lineal pieces of pre-finished crown molding 83 are provided with an upper kerf 18 and a lower kerf 19. As shown in FIG. 17, crown molding 83 is secured in place at a 45° angle by installing nails through the upper kerf into the ceiling, and by installing nails through the lower kerf into the wall. Lengths of resilient cord 27, or other desired filler means, are used to fill the kerfs and cover the heads of the nails.

“Fastener-less” crown molding corner receptacles are provided to transition lineal runs of crown molding 83 around corners, in a manner identical to the receptacles used in the previously described baseboard molding application. For example, a 90° outer corner crown molding receptacle 84, having a first receiver 86 and a second receiver 87 are shown in FIG. 15. Receivers 86 and 87 are sized and configured to receive end portions of the two pieces of crown molding 83 meeting at the 90° corner. A 90° outer corner juncture 88 is provided in the receptacle, to join the two receivers and maintain them in the proper orientation.

The corner receptacles also include internal ribs 41 and 42, to engage respective kerfs in the outer surfaces of the molding 83. Once the ends of the molding 83 are inserted into the receivers of the receptacle 84, the molding pieces are permanently affixed to the wall and to the ceiling. No nails, screws, or adhesives are necessary to hold the receptacle 84 in place.

A 90° inner corner crown molding receptacle 89 is also provided, to handle 90° transitions of the crown molding 83 through an inner corner. Crown molding receptacle 89 includes a first receiver 91 and a second receiver 92, identically configured as receivers 86 and 87 of the crown molding receptacle 84. An inner corner juncture 93 is also provided to join the two receivers together and maintain them in proper alignment within a 90° inner corner. In all other respects, receptacle 89 functions identically as receptacle 84 does, to form an integral component of the trim and molding installation without the use of fasteners or adhesives, to cover the ends of the crown molding pieces, and to present a smooth transition of the molding through a corner without the additional time and skill required for a miter cut.

What is claimed is:

1. A hidden fastening system for decorative trim or molding comprising:
a. an elongated piece of pre-finished trim or molding, said piece having an outer face including at least one elongated kerf therein, said kerf having a width and a depth;
b. a fastener, said fastener having an inner end, an outer end with a head thereon, and a shank extending between said inner end and said outer end, said width and said depth of said kerf being sufficient to accommodate said head in recessed relation below said outer face when said fastener is installed through said piece, with said inner end and a portion of said shank extending into a backing structure; and,
c. means for filling said kerf and covering said head of said fastener.

2. A system as in claim 1 in which said fastener is either a screw or a nail.

3. A system as in claim 1 in which said piece of trim or molding has a first end and a second end, and in which said elongated kerf extends from said first end to said second end.

4. A system as in claim 3 including a second kerf extending from said first end to said second end, said kerfs being in arranged in substantially parallel relation.

5. A system as in claim 1 in which said means for filling comprises a strip of rubber, plastic, wood, or composite material.

6. A system as in claim 1 in which said means for filling comprises an injectable fluid material, hardenable after said kerf is filled.

7. A system as in claim 1 in which said outer face includes a three-dimensional design feature, and in which said kerf is located adjacent or within said three-dimensional design feature.

8. A hidden fastening system for decorative trim or molding comprising:
a. an elongated piece of pre-finished trim or molding, said piece having an outer face including at least one elongated kerf therein, said kerf having a width and a depth;
b. a fastener, said fastener having an inner end, an outer end with a head thereon, and a shank extending between said inner end and said outer end, said width and said depth of said kerf being sufficient to accommodate said head in recessed relation below said outer face when said fastener is installed through said piece, with said inner end and at least a portion of said shank extending into a backing structure; and,
c. an elongated strip of resilient material, said strip having a transverse dimension sized to fit snugly within said kerf, and a length sufficient to fill said kerf and cover said head of said fastener.

9. A system as in claim 8 in which said elongated strip is plastic or rubber.

10. A hidden fastening system for decorative trim or molding comprising:
a. an elongated piece of pre-finished trim or molding, said piece having an outer face including at least one elongated kerf therein, said kerf having a width and a depth;
b. a fastener, said fastener having an inner end, an outer end with a head thereon, and a shank extending between said inner end and said outer end, said width and said depth of said kerf being sufficient to accommodate said head in recessed relation below said outer face when said fastener is installed through said piece, with said inner end and at least a portion of said shank extending into a backing structure; and,
c. an injectable fluid material located within and substantially filling said kerf, said fluid material being hardenable after said kerf is substantially filled.

11. A system as in claim 10 in which said injectable fluid material is caulking.

12. A receptacle for connecting two or more pieces of molding or trim, said receptacle comprising:
a. a first receiver having an open outer end and an inner end;
b. a second receiver having an open outer end and an inner end; and,
c. a juncture between said inner ends of said first and second receivers, each of said first and second receivers having an internal cavity extending from said open outer end to said inner end which is sized and configured to accommodate and cover an end portion of a piece of molding or trim inserted therein.

13. A receptacle as in claim 12 in which said juncture comprises an outside corner, and in which said first and second receivers have axes which are maintained at 90°, 120°, or 135° with respect to each other.

14. A receptacle as in claim 12 in which said juncture comprises an inside corner, and in which said first and second receivers have axes which are maintained at 90°, 120°, or 135 with respect to each other.

15. A receptacle as in claim 12 in which each of said first and second receivers includes retaining means for securing the molding or trim to the receptacle without the use of fasteners or adhesives.

16. A receptacle as in claim 15 in which said retaining means comprises an upper lip and a lower trough.

17. A receptacle as in claim 15 in which said retaining means comprises at least one rib.

18. A receptacle as in claim 12 in which said first and second receivers define respective planes which are oblique with respect to each other.

19. A receptacle as in claim 18 in which said first and second receivers are adapted to receive crown molding or trim.

20. A coupler for connecting two or more pieces of molding or trim, said coupler comprising: a first receiver and a second receiver, each of said first and second receivers being sized and configured to accommodate and cover an end portion of a piece of molding or trim inserted therein.

21. A coupler as in claim 20 in which each of said first and second receivers includes retaining means for securing the molding or trim to the coupler without the use of fasteners or adhesives.

22. A coupler as in claim 21 in which said retaining means comprises an upper lip and a lower trough.

23. A receptacle as in claim 21 in which said retaining means comprises at least one rib.
